(19) United States
(12) Patent Application Publication
(10) Pub. No.: US 2008/0042574 A1
(43) Pub. Date: Feb. 21, 2008

(54) Plasma display panel

(75) Inventors: Hsu-Pin Kao, Pingjhen City (TW); Jang-Jeng Liang, Taoyuan City (TW); Sheng-Wen Hsu, Taipei City (TW); Hsu-Chia Kao, Pingjhen City (TW); Yi-Chia Shan, Jhongli City (TW)

Correspondence Address: BIRCH STEWART KOLASCH & BIRCH, PO BOX 747, FALLS CHURCH, VA, 22040-0747, US

(73) Assignee: MARKETECH INTERNATIONAL CORP.

(21) Appl. No.: 11/889,826

(22) Filed: Aug. 16, 2007

(30) Foreign Application Priority Data
Aug. 18, 2006 (TW) 095130545

(51) Int. Cl. H01J 17/49

(52) U.S. Cl. 313/582

(57) ABSTRACT

A plasma display panel is provided. The plasma display panel includes a front plate, a back plate, a shadow mask, and a discharge destructive film. The shadow mask is located between the front plate and the back plate. The discharge destructive film is formed in a predetermined pattern between the shadow mask and the back plate. The discharge destructive film increases the firing voltages of some parts of the back plate. The discharge distance between the front plate and the back plate is accordingly increased. Thus, the luminous efficiency of the plasma display panel can be improved.

### BACKGROUND OF THE INVENTION

1. Field of the invention

The invention relates to a display apparatus and, more specifically, to a plasma display apparatus.

2. Description of the prior art

A plasma display panel (PDP) has many advantages such as high lightness, high efficiency, high contrast, high writing speed, and low cost. Thus, it is one of the current mainstream technologies of large-sized digital flat display panels.

As shown in FIG. 1A, a conventional plasma display panel 10 includes three main parts: a front plate 12, a back plate 14, and a shadow mask 16 between the front plate 12 and the back plate 14.

In general, the front plate 12 includes one first glass substrate 121, a plurality of transparent electrodes 122, a plurality of auxiliary electrodes 123, a transparent dielectric layer 124, and one first protective layer 125. The back plate 14 includes one second glass substrate 141, a plurality of address electrodes 142, one dielectric layer 143, and one second protective layer 144. The shadow mask 16 includes a plurality of barrier ribs 161 and a plurality of color phosphors 162. In this example, the marks 162A, 162B, and 162C represent red, green, and blue phosphors respectively.

Each of the independent spaces containing the color phosphors. 162 among the barrier ribs 161 can be seen as one luminous cell. One red luminous cell, one green luminous cell, and one blue luminous cell can construct one pixel of the plasma display panel 10. These luminous cells are filled with a mixture of noble gases such as He, Ne, Xe, etc. FIG. 1B is a schematic diagram of the shadow mask 16 and these address electrodes 142 viewed along the direction 18A. As shown in FIG. 1B, all luminous cells are arranged in order on the same plane, with the barrier ribs 161 as their frame. Besides, each of the luminous cells includes the red, green, and blue phosphors 162 respectively.

The transparent electrode 122 in the front plate 12 and the address electrode 142 in the back plate 14 can cooperate to generate high voltage electricity. In this way, the gases in all luminous cells will be triggered to discharge and radiate ultraviolet rays. The ultraviolet rays will excite these color phosphors 162 to generate visible lights of red, green, and blue. By controlling the transparent electrode 122 in the front plate 12 and the address electrode 142 in the back plate 14, the control circuit (not shown in the figure) of the plasma display panel 10 can decide whether the luminous cells radiate and what their radiation strength is. The beams radiated by these luminous cells can further constitute images including various colors.

In practical applications, these transparent electrodes 122 are usually conductible ITO or SnO₂ plated on the first glass substrate 121. The effect of the auxiliary electrodes 123 is to reduce the resistance of the transparent electrodes 122. The transparent dielectric layer 124 and the dielectric layer 143 are also called dielectric layers. They can store charges and achieve memory effect to keep images. The material of the first protective layer 125 and the second protective layer 144 is generally MgO. Its function is to prevent the wearing out of the electrodes.

Referring to FIG. 2, FIG. 2 is a schematic diagram of opposite discharge between the transparent electrodes 122 and the address electrode 142 corresponding to certain luminous cell. In the prior art, the discharge distance between the transparent electrodes 122 and the address electrode 142 is about equal to the distance between the front plate 12 and the back plate 14, and also equals to the thickness of the shadow mask 16 (generally 90˜150 μm). As those skilled in the art know, the discharge distance is in direct proportion to the discharge efficiency. Moreover, the higher the discharge efficiency is, the higher the lightness of these luminous cells. How to improve the luminous efficiency is always a researcher-concerned topic.

### SUMMARY OF THE INVENTION

A scope of the invention is to provide a method for improving the lighting efficiency of a plasma display panel (PDP). According to the invention, a preferred embodiment is a plasma display panel including a front plate, a back plate, a shadow mask, and a discharge destructive film. The shadow mask is located between the front plate and the back plate. The discharge destructive film is formed in a predetermined pattern between the shadow mask and the back plate. The discharge destructive film can increase the firing voltages of some parts of the back plate. By doing so, the discharge distance between the front plate and the back plate is increased. Therefore, the luminous efficiency of the plasma display panel will be improved.

The advantage and spirit of the invention may be understood by the following recitations together with the appended drawings.

### BRIEF DESCRIPTION OF THE APPENDED DRAWINGS

FIG. 1A and FIG. 1B show the structure of the plasma display panel (PDP) according to a prior art.

FIG. 2 is a schematic diagram of column discharge by the transparent electrodes and the address electrode corresponding to certain luminous cell.

FIG. 3A and FIG. 3B show the structure of the plasma display panel (PDP) according to a preferred embodiment of the invention.

FIG. 4 is a schematic diagram of the column discharge within certain luminous cell according to the invention.

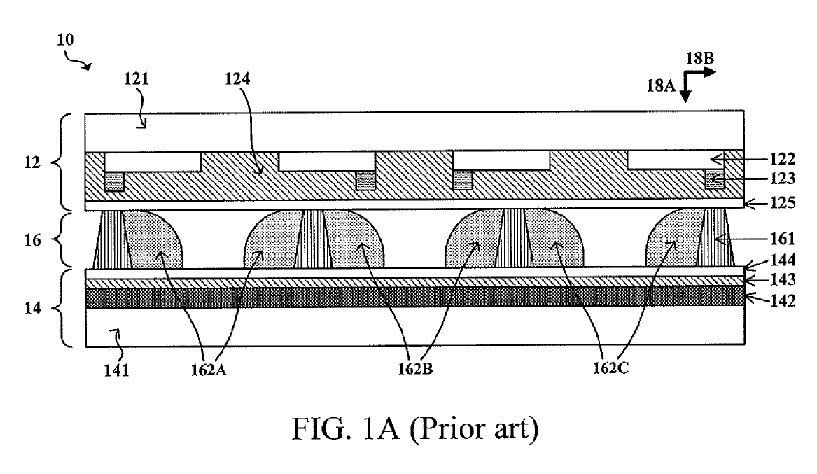

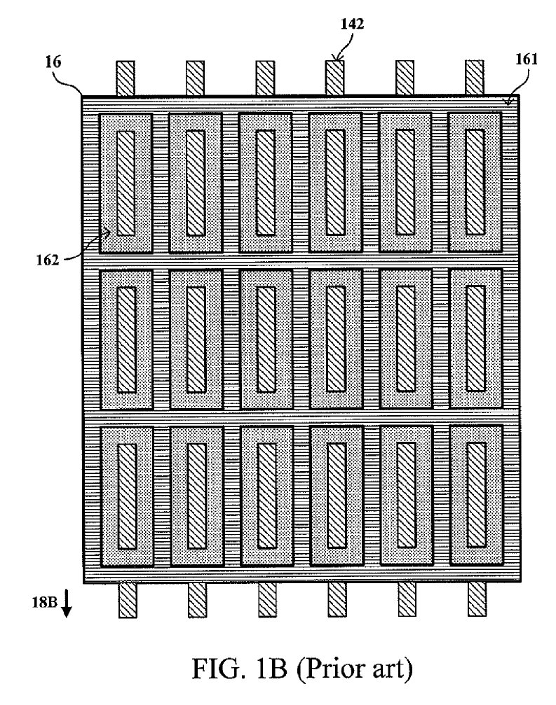

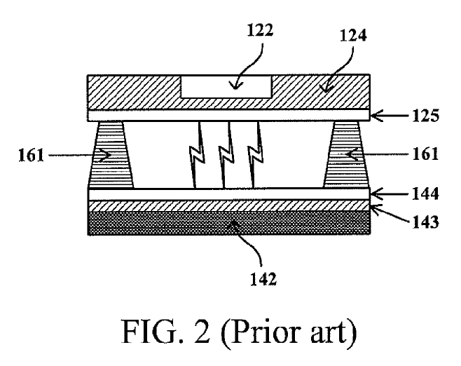

### DETAILED DESCRIPTION OF THE INVENTION

The invention provides a plasma display panel (PDP) with high luminous efficiency.

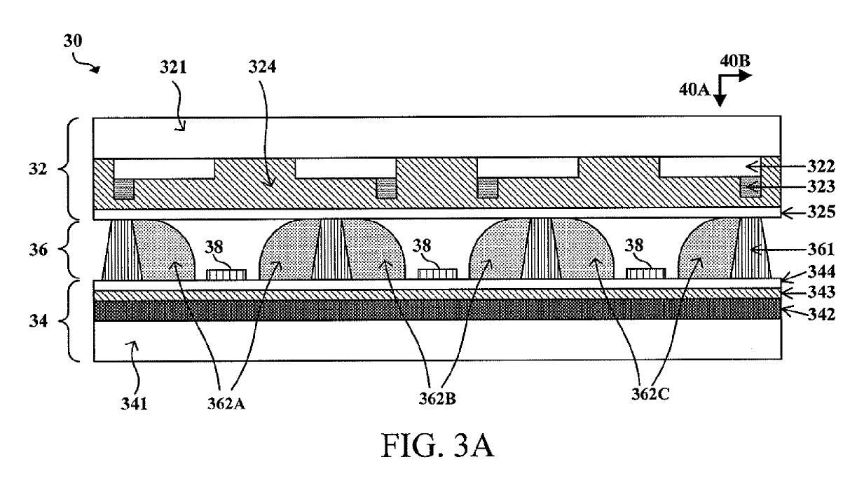

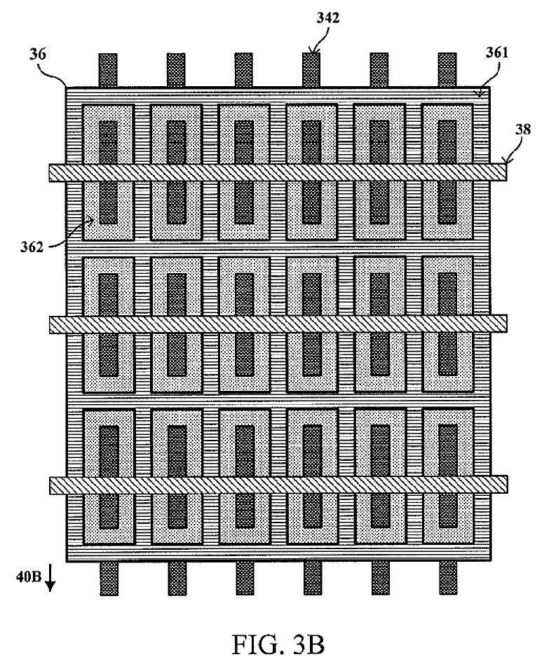

According to the invention, a preferred embodiment is a plasma display panel. Referring to FIG. 3A, FIG. 3A is a schematic diagram of the preferred embodiment. The plasma display panel 30 includes a front plate 32, a back plate 34, a shadow mask 36, and a discharge destructive film 38. The shadow mask 36 is located between the front plate 32 and the back plate 34. The discharge destructive film 38 is formed in a predetermined pattern between the shadow mask 36 and the back plate 34. In practical applications, the discharge destructive film 38 may include at least one material selected from SiO₂ and TiO₂.

In the embodiment, the front plate 32 includes a first glass substrate 321, a plurality of transparent electrodes 322, a plurality of auxiliary electrodes 323, a transparent dielectric layer 324, and a first protective layer 325. The back plate 34 includes a second glass substrate 341, a plurality of address electrodes 342, a dielectric layer 343, and a second protective layer 344. The shadow mask 36 includes a plurality of barrier ribs 361 and a plurality of color phosphors 362. The red, green, and blue phosphors are respectively represented by the marks 362A, 362B, and 362C. As those skilled in the art know, the devices included by the above mentioned front plate 32, back plate 34, and shadow mask 36 can have some differences in different plasma display panels. Therefore, the devices included by the front plate 32, back plate 34, and shadow mask 36, according to the invention, are not necessarily the same as those shown in FIG. 3A.

FIG. 3B is a schematic diagram of the shadow mask 36, the address electrodes 342, and the discharge destructive film 38 viewed along the direction of the arrow 40A. As shown in FIG. 3B, a plurality of luminous cells are arranged in order on the same plane with the barrier ribs 361 as a frame. Moreover, each of the luminous cells includes the red, green, and blue phosphors 362 respectively. In this example, the pattern of the discharge destructive film 38, which is perpendicular to the address electrodes 342, covers the middle region of all the luminous cells.

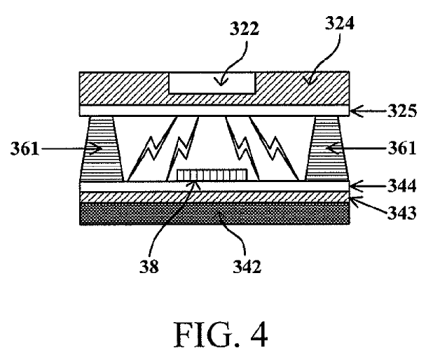

Referring to FIG. 4, FIG. 4 is a schematic diagram of opposite discharge between the transparent electrodes 322 and the address electrodes 342 corresponding to certain luminous cell in this embodiment. Because the middle region of the luminous cell is covered by the discharge destructive film 38, the firing voltage of the middle region will be higher than that of the uncovered regions. Therefore, when the opposite discharge between the transparent electrodes 322 and the address electrodes 342 occurs, the middle region covered by the discharge destructive film 38 will not discharge. By doing so, the discharge phenomenon will be generated in the regions not covered by the discharge destructive film 38. As shown in FIG. 4, the discharge distance in the luminous cell is longer than that in the prior art. Because the discharge distance is in direct proportion to the discharge efficiency, obviously, the discharge efficiency and the lightness of the plasma display panel in the invention will be higher than those in the prior art.

Besides, when the discharge occurs, there are two discharge regions in each of the luminous cells in the back plate according to the invention. This will make the distribution of the ultraviolet rays generated by the discharge phenomenon more uniform. In this way, the ultraviolet ray absorptivity of the color phosphors in the luminous cells will increase. It will also further improve the lightness of the plasma display panel.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A plasma display panel (PDP), comprising:
a front plate;
a back plate;
a shadow mask located between the front plate and the back plate; and
a discharge destructive film formed in a predetermined pattern between the shadow mask and the back plate.

2. The PDP of claim 1, wherein the front plate comprises a first glass substrate, a transparent electrode, an auxiliary electrode, a transparent dielectric layer, and a first protective layer.

3. The PDP of claim 2, wherein the material of the transparent electrode comprises indium tin oxide (ITO) or SnO₂.

4. The PDP of claim 2, wherein the material of the first protective layer comprises MgO.

5. The PDP of claim 1, wherein the back plate comprises a second glass substrate, an address electrode, a dielectric layer, and a second protective layer.

6. The PDP of claim 5, wherein the material of the second protective layer comprises MgO.

7. The PDP of claim 5, wherein the discharge destructive film is formed in the predetermined pattern between the shadow mask and the second protective layer.

8. The PDP of claim 7, wherein the discharge destructive film comprises at least one material selected from SiO₂ and TiO₂.

9. The PDP of claim 1, wherein on the back plate, a first region covered with the discharge destructive film has a first firing voltage, a second region not covered with the discharge destructive film has a second firing voltage, and the first firing voltage is higher than the second firing voltage.

10. The PDP of claim 1, wherein the shadow mask comprises barrier ribs and color phosphors.
